(19) United States
(12) Patent Application Publication
(10) Pub. No.: US 2008/0031227 A1
(43) Pub. Date: Feb. 7, 2008

(54) Method for delivering multimedia greeting data to calling party in IMS or other IP network

(76) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/541,298

(22) Filed: Sep. 29, 2006

(30) Foreign Application Priority Data
Aug. 4, 2006 (CN) 200610110059.1

(51) Int. Cl. H04L 12/66

(52) U.S. Cl. 370/352

(57) ABSTRACT

A system is implemented on an IMS network for automatically delivering multimedia greetings to calling terminals. A user configures a greeting profile stored on a called terminal, which includes at least one multimedia greeting file. The greeting file contains executable data configured for automatic execution (e.g., playback) on a mobile phone, computer, or other terminal, and may include audio, video, and/or other multimedia content. In operation, when the calling terminal initiates communication with the called terminal over the IMS network, if both terminals are multimedia capable, the network disables any resources that would otherwise be allocated for the initiated communication. Subsequently, the called terminal selects a greeting file in the profile, and transmits data from the selected file to the calling terminal. The selection is based on selection criteria in the profile and information about the calling terminal such as its ID and media capability.

This application is entitled to the benefit of and claims foreign priority under 35 U.S.C. §119 from Chinese Patent Application No. 200610110059.1, filed Aug. 4, 2006, the disclosure of which is hereby incorporated by reference.

### FIELD OF THE INVENTION

The present invention relates to communications and, more particularly, to user services for delivering content in an IMS-based network or other communication network.

### BACKGROUND OF THE INVENTION

The IP Multimedia Subsystem (“IMS”) is a standardized “next generation” networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of SIP (session initiation protocol). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

An IMS-based network 10 is shown in simplified form in FIG. 1. The IMS control architecture includes a home subscriber server (“HSS”) 12 and a call session control function (“CSCF”) 14, and may generally be divided into a services/application layer 16a, an IMS layer 16b, and a transport layer 16c. The HSS 12 is the central repository of all subscriber-specific authorizations and service profiles and preferences. The HSS 12 integrates several functions/elements, some of which may exist already (for example, in the home location register of wireless networks), including subscriber/user profile database, subscriber service permissions, authentication and authorization, subscriber preference settings, mobile authentication server, and the like. An SLF 18 (subscriber location function) is needed when multiple HSS's are used. The CSCF 14 carries out the primary SIP signaling functions in the network. The CSCF 14 includes several types of SIP servers, including a proxy-CSCF server (the first point of contact for device and controls authentication), an interrogating-CSCF server (the entry point of all SIP messages), and a serving-CSCF server, which manages session control functions. Additionally, application servers 20 host and execute services, and interface with the CSCF 14 using SIP. This allows third party providers to easily integrate and deploy their value added services on the IMS infrastructure. Examples of services include caller ID related services, call waiting, call holding, push to talk, conference call servers, voicemail, instant messaging, call blocking, and call forwarding. A circuit-switched (“CS”) network gateway 22 interfaces the IMS 10 with circuit-switched networks 24 such as a public switched telephone network (“PSTN”). The gateway 22 may include a BGCF (breakout gateway control function), which is an SIP server that includes routing functionality based on telephone numbers, an SGW (signaling gateway) that interfaces with the signaling plane of the network 24, an MGCF (media gateway controller function) for call control protocol conversion, and an MGW (media gateway) that interfaces with the media plane of the circuit-switched network 24. An MRF 26 (media resource function) may be provided as a media source in the network, e.g., for multimedia conferencing, text-to-speech conversation and speech recognition, and real-time transcoding of multimedia data, e.g., conversion between different codecs.

At the transport layer 16c, the IMS layer 16b is connected to a core broadband IP network 28, possibly through the MRF 26 and/or an IMS gateway 30. The IMS gateway 30 may include an IMS application layer gateway 32 (“IMS-ALG”) and a translation gateway 34 (“TrGW”) for facilitating communications with networks using different versions of the Internet protocol, e.g., IPv4 and IPv6. The core IP network 28 is also connected to one or more external IP packet data networks 36 (“IP PDN”), e.g., the Internet, and to other networks such as a DSL or other wire-line network 38, wireless local area networks (“WLAN”) 40, and wireless networks 42. Typically, one or more intermediate network elements are used for facilitating these connections, such as a WLAN access gateway (“WAG”) and/or WLAN packet data gateway (“PDG”) 44, a serving GPRS support node (“SGSN”) 46 and gateway GPRS service node (“GGSN”) 48, and a digital subscriber line access multiplexer (“DSLAM”) and broadband access server (“BAS”) 50. The SGSN 46 is responsible for mobility management and IP packet session management. It routes user packet traffic from the radio network 42 to the appropriate GGSN 48, providing access to external packet data networks, in this case the core network 28. The DSLAM 50 is a network device, usually located at a telephone company central office, or within a neighborhood serving area interface as part of a digital loop carrier, that receives signals from multiple customer DSL connections and aggregates the signals on a high-speed backbone line using multiplexing techniques. In this case, the DSLAM 50 connects the DSL network 38 with the core IP network 28.

The networks 38, 40, 42 may be functionally/logically connected to the CSCF 14 through various control/functional elements. For example, the IMS system may include a policy decision function (“PDF”) 52, which enables the access network to be managed using dynamic policies. Additional functional elements 54 (grouped together for simplicity of illustration) may include a service policy decision function (“SPDF”), an access-resource and admission control function (“A-RACF”), and a network attachment subsystem (“NASS”). The SPDF, for example, makes policy decisions using policy rules and forwards session and media related information, obtained from an application function, to the A-RACF for admission control purposes. The A-RACF is a functional element that performs resource reservation admission control and network policy assembly functions. For simplicity of illustration, some intermediate network elements such as access gateways and server nodes are not shown. Further explanation regarding the operation of an IMS network is available in the literature, and is known to those skilled in the art.

In an IMS-based network, as is generally the case with other communication networks, user terminals 56a, 56b provide a means for users to communicate with one another over the network(s). Each terminal is an electronic device with hardware and/or software-based functionality for communicating over a network, and typically including user input/output means such as a keyboard and display. Examples include computer terminals, as well as wireless units such as mobile phones, wireless PDA's, wireless devices with high-speed data transfer capabilities, such as those compliant with “3-G” or “4-G” standards, “WiFi”-equipped computer terminals, and the like. When one terminal 56a (e.g., a calling/caller terminal) initiates communication with another terminal 56b (e.g., a called/“callee” terminal), various signaling procedures are automatically carried out by the network, according to its communication protocols, in an attempt to open a communication channel between the two terminals. As part of this process, a status or alert indicator is typically displayed at each terminal indicating that a communication has been initiated. For example, text similar to “Status: Calling . . . ” may be displayed on the calling terminal 56a as a function of the terminal's programming. In an IMS network, however, additional functionality for providing information about the initiated communication to the calling party 56a is limited. For example, audio notifications for the calling party are limited to audible tones and announcements. In the case of the former, the audible tone is played at the calling terminal 56a to indicate that the recipient terminal 56b is being alerted as to the incoming communication. In the case of the latter, the announcement is provided to the calling terminal 56a from the MRF 26 or another media server in the IMS network 10, for a similar purpose. However, because the MRF/media server is controlled by the telecommunication service provider (e.g., phone company) or other network operator, the announcement function may be bypassed during periods of high call load. Additionally, multimedia data is not supported, and users cannot easily configure the announcements or other data transmission.

### SUMMARY OF THE INVENTION

An embodiment of the present invention relates to a method for communicating with a terminal over an IMS (IP Multimedia Subsystem) or other network, e.g., for delivering multimedia greeting messages or similar content. By “terminal,” it is meant an electronic device capable of communicating with other devices over a network, including, for example, computers and wireless units such as mobile phones, wireless PDA's, wireless devices with high-speed data transfer capabilities, such as those compliant with “3-G” or “4-G” standards, “WiFi”-equipped computer terminals, and the like. According to the method, a user of a first terminal configures a profile stored on the first terminal. The profile lists one or more files containing executable data. When a second terminal initiates communication with the first terminal, the first terminal transmits executable data from a selected one of the files to the second terminal. The data file may be selected based on selection criteria in the profile. By “executable data,” it is meant data that includes both content data (e.g., text, audio, and/or video) and an implied or explicit command for how the data is to be used. For example, the executable data may be a multimedia greeting that is automatically displayed/played on the second terminal.

In another embodiment, communication identifiers are used as the selection criteria. When a second terminal initiates communication with the first terminal, the communication identifier of the second terminal (e.g., the calling terminal) is cross-referenced to the profile stored on the first terminal for selecting a file having executable data. The selected data file may be indirectly or directly associated with the communication identifier in the profile. Additionally, the data file may be selected based on both the selection criteria and on media capability information received over the IMS network. The media capability information relates to a hardware and/or software configuration of the second terminal for executing executable data.

In another embodiment, the first terminal (e.g., the called terminal) transmits a message to the network, e.g., to an IMS server terminal such as an HSS or CSCF. The message relates to the transmission of the executable data in the selected data file from the first terminal to the second terminal. The IMS may keep a call record of the communication between the two terminals, including data relating to the transmission of the executable data.

In another embodiment, communication resources are managed on the network by determining whether the first terminal is configured to transmit executable data to the second terminal over the network, upon the second terminal initiating communication with the first terminal. Based upon this determination, network media resources are allocated for the communication between the first and second terminals. For example, network media resources for the communication between the first and second terminals may be disabled if it is determined that the first terminal is configured to transmit executable data to the second terminal. Additionally, network media resources for the communication between the first and second terminals may be allocated according to a standard network protocol if it is determined that the first terminal is not configured to transmit executable data to the second terminal. Network media resources may be further allocated based on a determination of whether the second terminal is configured to receive and execute the multimedia greeting data.

### BRIEF DESCRIPTION OF THE DRAWINGS

The present invention will be better understood from reading the following description of non-limiting embodiments, with reference to the attached drawings, wherein below:

FIG. 1 is a schematic view of an IMS (IP Multimedia Subsystem) network;

FIG. 2 is a schematic view of a system for delivering multimedia greetings or other executable data to calling parties in an IMS network, according to an embodiment of the present invention; and

FIGS. 3A-3C are flowcharts showing operation of a recipient/called terminal, IMS, and source/calling terminal, respectively, according to an embodiment of the present invention.

### DETAILED DESCRIPTION

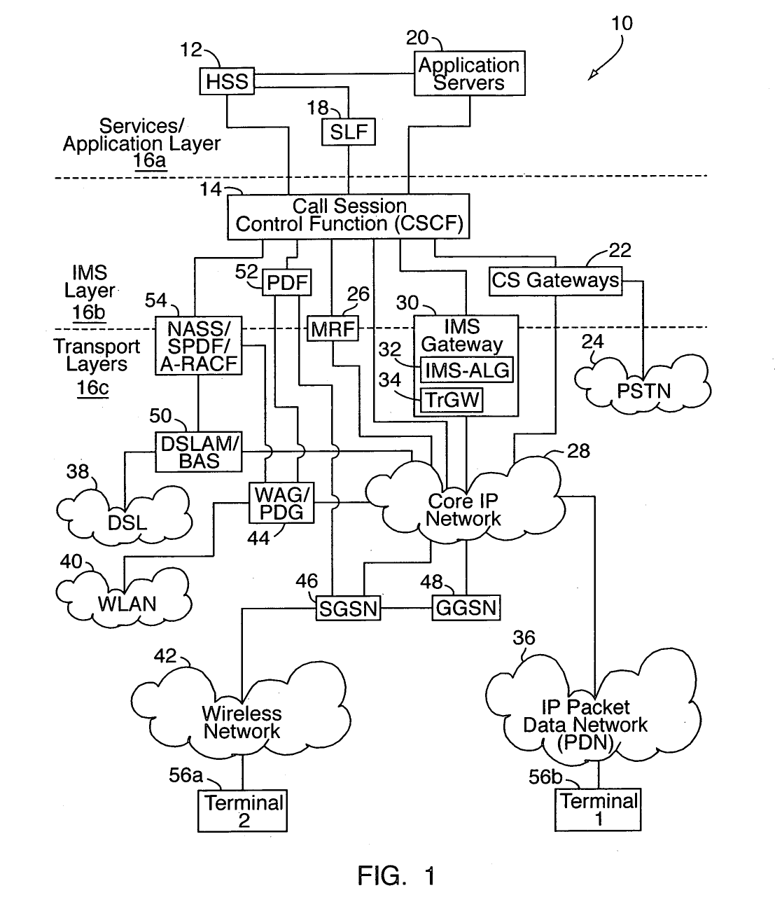

With reference to FIGS. 1-3C, a system 60 is implemented on or as part of an IMS (IP Multimedia Subsystem) network 10 for automatically delivering multimedia greetings 62a-62d to source terminals 64, e.g., the greetings are transmitted to computer terminals, wireless units, or other terminals initiating communications to recipient terminals 66. (As should be appreciated, “source” terminal relates to the calling/caller party, that is, the source of the communication, and “recipient” terminal to the party being called.) A user of a recipient terminal 66 configures a greeting profile or other data record 68, which is stored on the recipient terminal 66, e.g., in memory or other data storage 70. The profile 68 includes at least one multimedia greeting 62a-62d, which is created/selected by the user and downloaded to the recipient terminal 66 from a media source 72. Each greeting 62a-62d is a data set or file having executable data 74 configured for automatic execution (e.g., playback) on a mobile phone, computer, or other terminal 64, 66, and may include audio, video, text, and/or other multimedia content.

Initially, the user of the recipient terminal 66 alerts or otherwise informs the IMS network 10 that the recipient terminal 66 is configured for transmitting multimedia greetings 62a-62d to calling parties. For example, information to this effect may be included in a subscriber record 76 associated with the recipient terminal 66 and stored in a subscriber database 78 on the HSS (home subscriber server) 12. When a source terminal 64 initiates communication with another terminal (e.g., the recipient terminal 66) over the network 10, the IMS network 10 determines if the recipient terminal 66 is configured for transmitting multimedia greetings 62a-62d by querying the HSS subscriber database 78. If not, the communication continues as it normally would under the communication protocol(s) of the network 10. If so, the network 10 disables or de-allocates any media server resources that would otherwise be allocated for alerting the calling party 64 in relation to the initiated communication. Subsequently, after the recipient terminal 66 is notified of the initiated communication, the recipient terminal 66 selects one of the greetings or other data files 62a-62d in the profile 68, and transmits executable data 74 from the selected file to the source terminal 64 over the network 10. The selection may be based on one or more selection criteria in the profile 68 and on “terminal information” 80 received at the recipient terminal 66. The terminal information 80 is information relating to the source terminal 64, such as a communication identifier 82 of the source terminal and information 84 relating to the media execution/playback configuration and/or capabilities of the source terminal 64.

The system 60 of the present invention will typically be implemented on an IMS network 10. By “IMS network,” it is meant a communication network having (or working in conjunction with) an IP Multimedia Subsystem, e.g., as generally illustrated in FIG. 1. The IMS network 10 may include an IMS portion and a number of IP (Internet protocol)-based and other networks functionally interconnected by the IMS. The IMS-interconnected networks may include the Internet 36, PSTN's 24 and other wire-line networks, and wireless networks 40, 42 such as those using CDMA, GSM, IEEE 802.11x, and/or UMTS communications or the like. As noted above, the terminals 64, 66 are electronic devices capable of communicating with one another over the network(s) 10, 24, 28, 36, 38, 40, and/or 42, and may include, for example, computer terminals, wire-line connected communication devices such as conventional telephones and enhanced/multimedia-capable telephones, and/or wireless units such as mobile phones, wireless PDA's, wireless devices with high-speed data transfer capabilities, such as those compliant with “3-G” or “4-G” standards, “WiFi”-equipped computer terminals, and the like. The terminals 64, 66 communicate with one another over the network 10 in a standard manner, depending on the particular networks used and the particular type of terminals. For example, in the case of wireless units and a wireless network 42, the network 42 may include one or more fixed base stations (not shown) having various transceivers and antennae for wireless, radio-frequency (RF) communications with the wireless units over one or more RF channels, in a manner based on the wireless communication method and protocol used. A radio network controller interconnects the base stations and performs the signaling functions necessary to establish calls and other data transfer to and from the wireless units. It also acts as the interface between the wireless/RF end of the network and the wire-line portion of the network, including the IMS and other networks.

Generally speaking, the system 60 may be implemented as two functional blocks, namely, a signaling application 86 in place on the network 10 and a multimedia greeting or data transfer application 88 in place on the recipient terminal 66. Each application 86, 88 is a script, other software program, suite of software programs, and/or hardware or hardware/software module configured for implementing functional portions of the system 60 as described herein in conjunction with existing components/functions of the network and/or terminal. For example, the multimedia greeting application 88 on the recipient terminal 66 may be implemented as part of the terminal's existing programming that controls the terminal for carrying out communications over the network and/or that provides a user interface for configuring the terminal and accessing terminal functions. Thus, the multimedia greeting application 88 could include a user interface portion 90 accessible, for example, through the terminal's menu system. The interface portion 90 would allow a user to access and configure the profile 68, and to configure the application 88 such as enabling or disabling the transmission of multimedia greetings or other executable data 74. The signaling application 86 on the network 10 could be implemented as an adjunct to the network's existing signaling functionality, e.g., in place on the HSS 12, the CSCF 14, another network server, or on one or more network components (such as a radio network controller, mobile switching center, data router, or the like) where message, call routing, and/or other communication functions are carried out in the IMS network 10.

For using the system 60, the user of the recipient terminal 66 populates the profile 68 with one or more files 62a-62d, each containing executable data, e.g., a multimedia greeting. The files 62a-62d may include stock greeting/data files “pre-loaded” on the terminal 66 by the manufacturer. For example, one of the pre-loaded data files could be a generic animated character or scene 92 with an accompanying audio track 94 modifiable/customizable by the user for inclusion of the user's name or other information therein. Alternatively, the user may create or otherwise provide or obtain the data files 62a-62d, from a media source 72 or otherwise. Media sources include multimedia authoring software or the like on the terminal 66 itself or on another terminal accessible to the user, visual content sources such as digital video cameras and still cameras, sound capture devices such a wireless unit microphone and vocoder, other microphones and audio capture cards, a file database accessible to users over the network 10 as part of the system 60, and third-party sources such as Internet websites. Files 62a-62d may be downloaded and stored on the terminal 66 in a standard manner. For example, if the terminal 66 is configured for accessing the Internet, files could be selected on an Internet website, downloaded to the terminal 66 over the network, and stored in a designated or general purpose directory in the terminal's memory/data storage 70.

Each greeting 62a-62d is a file containing executable data configured for automatic execution on a mobile phone, computer, or other terminal 64, 66. (As should be appreciated, to the extent the storage and/or transmission of a greeting is file-based, or otherwise, the greeting 62a-62d may include one file or several sub-files, e.g., a pictorial content file and an audio content file.) The executable data will typically include both content data (e.g., audio, video, pictorial, text, and/or other multimedia content) and an implied or explicit command for how the content data is to be automatically used once received at a source terminal 64. That is, there may be an actual command included with the content data, or the formatting and/or content of the executable data may dictate the manner of its automatic execution. For example, in the case of a multimedia greeting, the visual content portion of the greeting is automatically displayed on the source terminal's display, and the audio content portion of the greeting, if any, is played over the terminal's speaker, typically concurrently with the data being received at the terminal. (In other words, for a greeting, it is typically the case that the executable data 74 will be streamed to the source terminal for execution as soon as the data 74 is received, or possibly with a slight delay due to buffering. Other options include executing the data once all the data from the data file 62a-62d is downloaded to the source terminal 64.)

The profile 68 is stored on the recipient terminal 66, and is accessible to the user via the user interface 90. The profile 68 can be configured in various manners depending on a desired level of functionality in the system. In a simple case, the profile 68 includes a single data file 62a, which is transmitted to calling/source terminals 64 when possible, that is, if the source terminal is configured for playback of multimedia greetings. (As should be appreciated, the profile may contain a listing of multiple files 62a-62d with the user pre-selecting or pre-designating one of the files for transmission.) Alternatively, the profile 68 may be configured to allow a user to add various communication identifiers ID_A-ID_H to the profile 68. For example, the communication identifiers may be associated with terminals 64 that are expected to initiate communications with the recipient terminal 66, such as terminals 64 operated by a user's friends, family, business associates, and other acquaintances. The user then associates a greeting or other executable data file 62a-62c with each communication identifier ID_A-ID_H. This may be done in a list-like manner, e.g., by listing the communication identifiers and associating a data file with each identifier. Alternatively, communication identifiers may be grouped together into categories 96a-96c, with each category having an associated greeting and a list 98a-98c of identifiers. For example, there may be different “friends” categories 96a, 96b with respective greetings 62a, 62b, a “family” category (not shown), and a “business” category 96c with a greeting 62c. There may also be a default category 96d with a default greeting 62d. The system may be configured to allow the user to select the number of categories, and to customize the categories such as changing category names. Also, the profile may include additional information, such as the names of persons associated with the identifiers ID_A-ID_H.

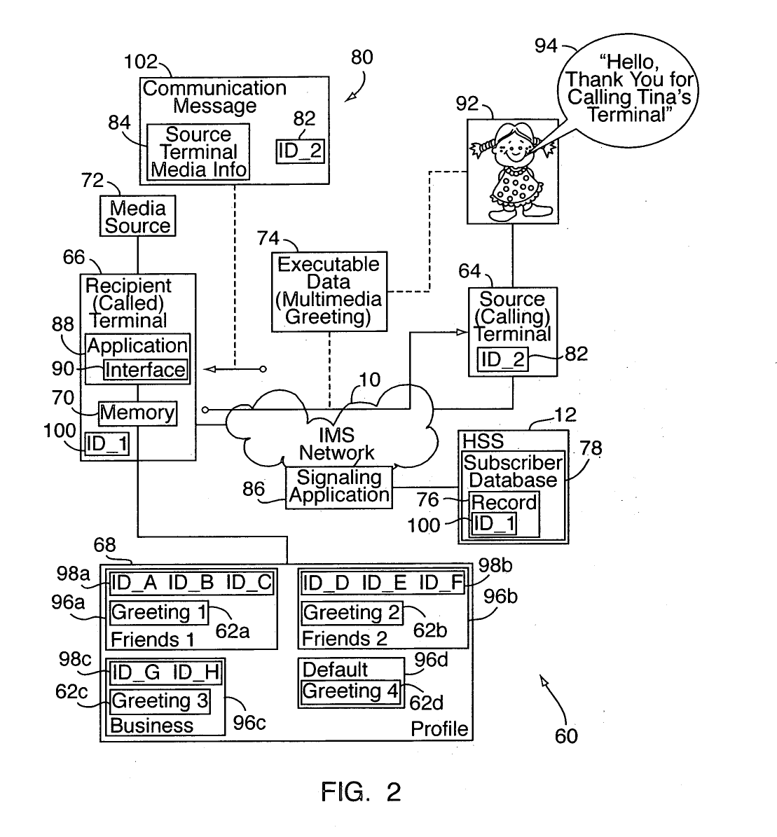

In operation, when a source terminal 64 initiates communication with the recipient terminal 66, if the profile 68 contains a single greeting or other executable data file 62a (or a single designated file), then the criterion for selecting a file for transmission to a source terminal 64 is an implied criterion, that is, the file 62a is selected by virtue of being the only file or the only designated file in the profile. If the profile 68 contains multiple files 62a-62d associated with multiple communication identifiers, as shown in FIG. 2, then a file is selected for transmission by cross-referencing the communication identifier 82 of the source terminal 64 to the identifiers ID_A-ID_H listed in the profile 68. If the identifier 82 is listed, then the file associated with the identifier in the profile is selected for transmission. If the identifier 82 is not listed, then the default file 62d is selected.

After the recipient terminal user sets up the profile 68, the IMS network 10 is informed that the recipient terminal 66 is configured for transmitting multimedia greetings 62a-62d to calling parties. This may involve the user selecting a command causing the greeting application 88 to send a message to this effect to the signaling application 86 or elsewhere in the IMS network 10. Alternatively, the greeting application 88 can be configured for automatically sending such a message or other signal in one of several ways. For example, the application 88 could be configured to send a message/signal when the profile 68 is established and adequately configured (e.g., populated with at least one greeting file), and/or when the greeting transmission is “turned on,” if the application 88 includes an option for enabling and disabling the transmission of multimedia greetings. Alternatively, the recipient terminal 66 could be configured so that when the IMS network 10 first contacts the terminal 66 upon initiation of a communication from a source terminal 64 (e.g., a signaling message from the network according to the communication protocol in place on the network), the recipient terminal 66 responds with a message/signal indicating that it is configured to transmit multimedia greeting data or other executable data. Such a message/signal could be included as part of a standard response message sent from the recipient terminal 66 to the network 10 according to the network's communication protocol. If the system is configured for the IMS network 10 to be informed in advance of the recipient terminal's capability for transmitting multimedia greetings, this information may be added to a subscriber record 76 associated with the recipient terminal 66 and stored in a subscriber database 78 on the HSS (home subscriber server) 12. For associating the subscriber record 76 with the recipient terminal 66, the subscriber record 76 may include the communication identifier 100 of the recipient terminal, or another identifier or identifiers or other information.

As should be appreciated, as a prerequisite for using the system 60, the user may be required to register with the IMS network 10, for billing purposes or the like. Accordingly, the IMS network 10 may include an interface for user registration, such as an Internet website or phone registration.

When a source terminal 64 initiates communication with another terminal (e.g., the recipient terminal 66) over the network 10, the IMS network 10/signaling application 86 determines if the recipient terminal 66 is configured for transmitting multimedia greetings 62a-62d. As noted, this may be done by the IMS network 10 screening a signal/message received from the recipient terminal 66 for an indication that the recipient terminal 66 is configured for transmitting multimedia greetings. Alternatively, the IMS network 10 may query the HSS subscriber database 78. For this, the IMS network 10 cross-references the communication identifier 100 of the recipient terminal 66 (included in an initiating signal received from the source terminal) to the database 78 for finding the record 76 associated with the recipient terminal 66. The record 76 is then accessed for determining if the record contains an entry or field indicating that the recipient terminal 66 is configured for transmitting multimedia greetings or other executable data 74.

If it is determined that the recipient terminal 66 is not configured for transmitting multimedia greetings (including the possibility of the greeting feature being selectively disabled on the recipient terminal 66), the communication continues as it normally would under the communication protocols of the network 10, including the possibility of the IMS network 10 allocating media server resources for initiating a standard/stock alert at the source terminal such as an audio tone or the like. If it is determined that the recipient terminal 66 is configured for transmitting multimedia greetings, the network 10 disables any media server resources that would otherwise be allocated for alerting the calling party 64 in relation to the initiated communication. Allocations of media server resources may also be based on the source terminal's media capabilities. For example, if the IMS network determines that the source terminal is not configured for the playback of multimedia greetings, it may allocate media server resources for transmitting a standard network-based greeting from the media server to the source terminal.

As part of the standard communication process, and possibly before and/or after determining that the recipient terminal is multimedia-capable, the IMS network 10 notifies the recipient terminal of the initiated communication through one or more signaling messages 102, e.g., an SIP “INVITE” message. In the system 60, at least one of these messages will typically include source terminal information 80. As noted above, the terminal information 80 is information relating to the source terminal 64, such as the communication identifier 82 of the source terminal and information 84 relating to the media execution/playback configuration and capabilities of the source terminal 64. For example, the media configuration information 84 may include an indication of whether the source terminal 64 is able to execute the executable data 74 (e.g., play a multimedia greeting), and, if so, the multimedia codec used or preferred by the source terminal for playback of multimedia greetings. (A codec is a device or program capable of performing encoding and decoding operations on a digital data stream or signal. In many cases a terminal will be outfitted with one or several standard multimedia-related codecs, allowing the terminal to decode incoming data 74 formatted according to those codecs.) Once the recipient terminal 66 receives the source terminal information 80, the recipient terminal 66 selects a greeting file 62a-62d for transmission to the source terminal 64. The selection is based at least in part on the source terminal information 80. For example, if the source terminal 64 is not capable of playing multimedia greetings, then no file or other data 74 will be selected by the recipient terminal 66. If the profile 68 includes only one designated file 62a, then the file 62a will be selected by virtue of being the only designated file. If the profile 68 includes multiple files 62a-62d in association with various communication identifiers ID_A-ID_H, then a file may be selected by cross-referencing the communication identifier 82 of the source terminal to the profile 68, as described above. Files 62a-62d may also be selected and/or configured based on the media information 84, e.g., there may be multiple versions of the same file for different codes or the like, or the data in the file may be encoded according to a particular codec (or codecs) prior to transmission.

Once a file 62a-62d is selected, the recipient terminal 66 transmits data 74 from the selected file to the source terminal 64 over the network 10 in a standard manner, e.g., packet data addressed to the source terminal 64. The data 74 is received by the source terminal 64 and executed according to the type and format of the data 74. In the case of streamed executable data 74 (constituting a multimedia greeting), for example, the data will typically be executed substantially immediately (e.g., either immediately or after a short time period required for data buffering) upon receipt at the source terminal 64, for starting playback of the greeting as soon as possible. Alternatively, the data 74 may be executed only after all the data is received. In the case of a greeting, the IMS network 10 may monitor the status of the recipient terminal for alerting the source terminal to halt execution of the data when the communication is answered at the recipient terminal. Additionally, the recipient terminal may be configured to halt transmission of the data 74 when the user of the recipient terminal answers the communication initiated by the source terminal.

The IMS network 10 may be further configured to record information relating to the transmission of the data 74 from the recipient terminal to the source terminal. For example, according to the communication protocols on the network, the recipient terminal will typically transmit one or more signaling messages to the network for carrying out communications. In one of these messages, e.g., an SIP “ALERTING” message, the recipient terminal 66 may include information indicating that the recipient terminal 66 has transmitted (or will be transmitting) multimedia greeting data or other data to the source terminal. The IMS network would then append a call record or the like (e.g., a standard record of the call/communication between the two terminals) to indicate that multimedia data was transmitted, possibly including the amount of data transmitted and/or the data transmission rate.

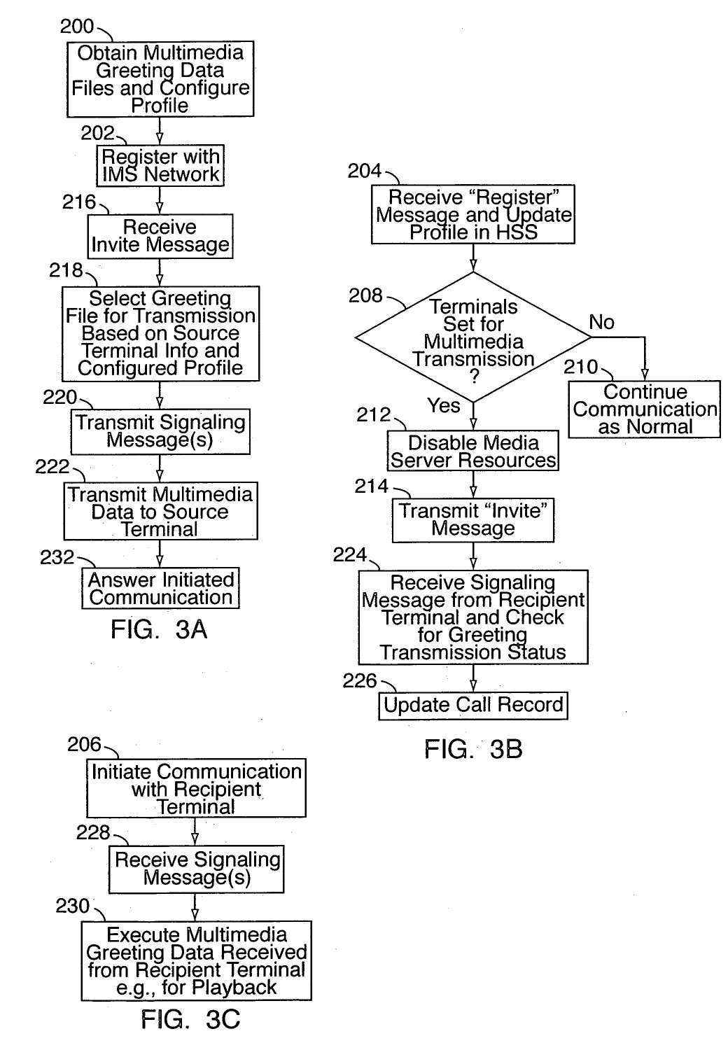

FIGS. 3A-3C are illustrative of one example of how the system 60 could be configured for operation over an IMS network 10, for a recipient terminal 66 (FIG. 3A), the IMS 10 (FIG. 3B), and a source terminal 64 (FIG. 3C). At Step 200, a user of a recipient terminal 66 configures a multimedia greeting profile 68 on the recipient terminal 66, including obtaining, adding, selecting, and/or configuring multimedia greeting files 62a-62d to the profile 68, e.g., in a manner as described above. The greeting files 62a-62d may be associated with particular communication identifiers ID_A-ID_H, either alone or in groups. The profile 68 may also be configured to account for calling party multimedia capability information 84. The profile 68 may be configured through a user interface 90 on the recipient terminal 66, which is part of a greeting application program 88 running on the terminal. The application 88 could be pre-installed by the terminal manufacturer, added as part of a software/firmware update, or obtained as downloaded software from a service provider server terminal accessible over the network 10. At Step 202, the user registers with the IMS network 10 for using the system 60. For example, the user can initiate transmission of an SIP “REGISTER” message to the signaling application 86 and/or HSS 12 containing a header indicating that the recipient terminal is to be the source of multimedia greeting data 74 for transmission to calling parties. The message could also contain information about the recipient terminal's capability and/or configuration for transmitting greeting data 74, e.g., available codecs and the like. At Step 204, the signaling application 86 receives the REGISTER message and updates the subscriber record 76 associated with the recipient terminal 66 in the HSS subscriber database 78, indicating that the recipient terminal has been designated for transmitting multimedia greeting data to calling parties 64.

At Step 206, a source terminal 64 initiates communication with the recipient terminal 66 in a standard manner over the network 10, e.g., by transmitting a message to the IMS network containing, among other data, the communication identifier 100 of the recipient terminal 66. At Step 208, the IMS network 10 determines if the recipient terminal 66 is set for transmitting multimedia greetings or other executable data, and if the source terminal 64 is capable of playing/executing executable data in a manner compatible with the recipient terminal. (In other words, the relevant query may be whether the source terminal is capable of executing the data provided by the recipient terminal.) This may be done by correlating the respective communication identifiers of the terminals to the subscriber database 78, and accessing the subscriber records associated with the terminals. Alternatively, one or both terminals can provide this information in signaling messages. If the recipient terminal 66 is not set for transmitting executable data 74, or if the source terminal 64 is incapable of executing data transmitted from the recipient terminal 66, the communication is continued in the usual manner over the network as at Step 210, including allocating network resources for the network media server to transmit an audio alert or announcement to the calling party. If the recipient terminal 66 is set for transmitting executable data 74, and if the source terminal 64 is able to execute data received from the recipient terminal, at Step 212 the IMS network 10 disables the audio alert or announcement from the network media server, for allowing the recipient terminal to instead transmit the data 74 to the source terminal. At Step 214, the IMS network 10 transmits one or more signaling messages to one or both terminals 64, 66, including an INVITE message 102 to the recipient terminal 66. The message 102 contains the source terminal (calling party) communication identifier 82 and calling party media capability information 84.

At Step 216, the recipient terminal 66 receives the INVITE message 102. At Step 218, the recipient terminal 66 uses the information in the INVITE message 102 as a basis for selecting a multimedia greeting file 62a-62d in the recipient terminal profile 68, according to the profile's implied or explicit selection criteria. At Step 220, the recipient terminal 66 responds to the INVITE message with one or more signaling messages back to the IMS network 10. For example, the recipient terminal might respond with an ALERTING message containing an SIP “Alert-Info” header indicating that the recipient terminal will be transmitting multimedia greeting data itself. At Step 222, the recipient terminal 66 transmits data 74 from the selected file to the source terminal 64. For example, the recipient terminal 66 may insert the data 74 as a media stream into RTP (real-time transport protocol) traffic towards the calling party endpoint 64. At Step 224, when the IMS 10 receives the ALERTING message from the recipient terminal, it checks the Alert-Info header for the status of the greeting transmission, e.g., whether the recipient terminal will or will not be transmitting the greeting data 74 to the source terminal 64. At Step 226, the IMS 10 optionally marks/updates a call record (or other record) for the communication between the two terminals to include information relating to the transmission of the multimedia data 74 from the recipient terminal to the source terminal, e.g., that multimedia data was transmitted, the amount of data transmitted, or the like. This information may be used for billing purposes.

After initiating the communication at Step 206, the source terminal 64 may receive data traffic or other signals from various sources in the network 10. For example, the source terminal may act as a network node for data pass-through and/or re-transmission. In such a case, the source terminal 64 may be configured to drop all unwanted traffic received from unknown resources. Before receiving a signaling message from the network 10 relating to the communication with the recipient terminal 66, the source terminal 64 stays in an inactive state, dropping all unwanted traffic in this state. At Step 228, the source terminal receives a signaling message from the network 10 relating to the communication with the recipient terminal 66. For example, this may be an SIP “ALERTING” message having an “Alert-Info” header and SDP data including the IP address of the recipient terminal and the media codec of the data 74. (SDP, the session description protocol, describes multimedia sessions for the purposes of session announcement, session invitation, and other forms of multimedia session initiation.) At Step 230, the source terminal 64 receives the multimedia greeting data or other executable data 74 and executes it according to data format, codec, etc., for playback of the greeting as video 92, audio 94, and the like. For example, once the ALERTING message is received at the calling party endpoint, the source terminal may (i) check the Alert-Info header and SDP, (ii) receive the traffic 74 sent from the IP address indicated in the SDP, and (iii) decode the media stream 74 based on the media codec set in the SDP for playback of the multimedia greeting.

At Step 232, after an “incoming call” alert or the like is initiated on the recipient terminal, the incoming communication is answered at the recipient terminal, e.g., the user of the recipient terminal selects a “call answer” function/option on the terminal 66. Once the call is answered, transmission of the data 74 from the recipient terminal will be halted, and various signaling messages may be transmitted between the terminals and network for establishing an ongoing communication path between the two terminals. For example, the recipient terminal may transmit an SIP “200OK” message with media information in SDP indicating what codec the recipient terminal wants to use for the call. This may be a different codec from the one used for the multimedia data 74. Other signaling steps are omitted for simplicity of explanation, but would be carried out in a standard manner depending on the particular communication protocols in place in the network 10.

Since certain changes may be made in the above-described method for delivering multimedia greeting data to a calling party in an IMS-based or other IP network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for communicating with at least one terminal over a network, said method comprising the steps of:
initiating communication with a first terminal over the network, said communication being initiated at a second terminal; and
receiving executable data from the first terminal, wherein the executable data is configured for automatic execution on the second terminal.

2. The method of claim 1 wherein:
the executable data is a multimedia greeting; and
the method further comprises initiating playback of the multimedia greeting on the second terminal.

3. The method of claim 2 wherein the network is an IMS network and the executable data is received in packet-data form over the IMS network.

4. A method for communicating with at least one terminal over a network, said method comprising the steps of:
selecting a data file stored on a first terminal based on at least one selection criterion, said data file including executable data, upon a second terminal initiating communication with the first terminal; and
transmitting the executable data in the selected data file to the second terminal.

5. The method of claim 4 wherein the transmitted data is configured for automatic execution on the second terminal as a multimedia greeting.

6. The method of claim 5 wherein the network is an IMS network and the transmitted data is transmitted in packet-data form over the IMS network.

7. The method of claim 6 further comprising:
cross-referencing a communication identifier of the second terminal to a profile stored on the first terminal for selection of said data file, wherein the data file is indirectly or directly associated with the communication identifier in the profile.

8. The method of claim 6 wherein the data file is additionally selected based on media capability information received over the IMS network, said media capability information relating to a hardware and/or software configuration of the second terminal for executing multimedia data.

9. The method of claim 8 further comprising:
selecting a codec for the transmitted data based at least in part on the media capability information of the second terminal.

10. The method of claim 6 further comprising:
transmitting a message from the first terminal to an IMS server terminal, said message relating to the transmission of the executable data from the first terminal to the second terminal.

11. The method of claim 10 further comprising:
storing call data relating to the message in a call record on the IMS server terminal, said call record being associated with the first terminal, and said call data indicating that the first terminal transmitted the executable data to the second terminal.

12. The method of claim 4 further comprising:
transmitting a message from the first terminal to a network server terminal, said message relating to the transmission of the executable data from the first terminal to the second terminal; and
storing call data relating to the message in a call record on the network server terminal, said call record being associated with the first terminal, and said call data indicating that the first terminal transmitted the executable data to the second terminal.

13. A method for managing communication resources in a network, said method comprising the steps of:
determining whether a first terminal is configured to transmit executable data to a second terminal over the network, upon the second terminal initiating communication with the first terminal; and
allocating network media resources for the communication between the first and second terminals based on said determination.

14. The method of claim 13 further comprising:
disabling network media resources for the communication between the first and second terminals if it is determined that the first terminal is configured to transmit executable data to the second terminal; and
allocating network media resources for the communication between the first and second terminals according to a network protocol if it is determined that the first terminal is not configured to transmit executable data to the second terminal.

15. The method of claim 14 further comprising:
cross-referencing a communication identifier of the first terminal to a record associated with the first terminal, said record being stored on a network server terminal, for determining whether the first terminal is configured to transmit executable data to the second terminal.

16. The method of claim 13 wherein the executable data is configured for automatic execution as a multimedia greeting on the second terminal.

17. The method of claim 16 further comprising:
further allocating said network media resources based on a determination of whether the second terminal is configured to execute the executable data.

18. The method of claim 17 further comprising:
disabling network media resources for the communication between the first and second terminals if it is determined that the first terminal is configured to transmit the executable data to the second terminal and that the second terminal is configured to execute the executable data; and
allocating network media resources for the communication between the first and second terminals according to a network protocol if it is determined that the first terminal is not configured to transmit the executable data to the second terminal and/or that the second terminal is not configured to execute the executable data.

19. The method of claim 13 further comprising:
receiving, at a network server terminal, a message from the first terminal relating to the transmission of the executable data from the first terminal to the second terminal.

20. The method of claim 19 further comprising:
storing call data relating to the message in a call record stored on the network server terminal, said call record being associated with the first terminal, and said call data indicating that the first terminal transmitted the executable data to the second terminal.
